(19) United States
(12) Patent Application Publication
(10) Pub. No.: US 2018/0190050 A1
(43) Pub. Date: Jul. 5, 2018

(54) SYSTEM AND METHOD FOR CONTACT CARD GENERATION WITH CONTROLLED ACCESS MANAGEMENT

(71) Applicant: KONICA MINOLTA LABORATORY U.S.A., INC., San Mateo, CA (US)

(72) Inventor: Shaun PINNEY, Newark, CA (US)

(21) Appl. No.: 15/396,265

(22) Filed: Dec. 30, 2016

(51) Int. Cl. G07C 9/00

(52) U.S. Cl. CPC G07C 9/00103; G06F 17/30887

(57) ABSTRACT

Embodiments of the present invention relate to systems and methods for generating contact cards, such as printed business cards. Additionally, the present invention relates to systems and management to allow individuals or employees to generate contact cards in a controlled manner, and to provide a mechanism to allow card recipients to obtain selective information access by virtue of information furnished with the card, and access configurations tracked to a unique ID associated with the card. Additionally, information distributed to recipients can be controlled by a pre-stored access level associated with unique recipient IDs. Further embodiments of the present invention provide for electronic generation, distribution, and post-distribution tracking of contact card information.

### DESCRIPTION OF THE INVENTION

### Field of the Invention

The present invention relates to systems and methods for generating contact cards, such as printed business cards. Additionally, the present invention relates to systems and management to allow individuals or employees to generate contact cards in a controlled manner, and to provide a mechanism to allow card recipients to obtain selective information access by virtue of information furnished with the card. Additional embodiments of the present invention provide for electronic generation, distribution, and post-distribution tracking of contact card information.

### BACKGROUND OF THE INVENTION

Business cards have been used for many years, with documented cases dating back at least to the late 1800's. Business cards have been used as a handy mechanism to provide contact information to allow a colleague, business contact, or other individual to take away information and to return contact with the card provider at a later date. Electronic versions of contact cards have evolved into formats such as the vCard standard, allowing electronic interchange of business contact information. However, existing business contact cards, whether printed as documents or implemented in electronic formats all suffer from the same limitation—namely, that the information is static, and provides no mechanism to customize the information that can be provided to the recipient upon recipient's subsequent return call or login. Furthermore, present-day business cards, whether printed or electronic, lack a mechanism to track access by the card recipients and to expand, contract, or revoke access privileges to information provided to a recipient upon their later contact. Additionally, card providers are often limited in their ability to select the information that is displayed by the business contact cards, whether tailored to the recipient or not. Put another way, potentially sensitive contact information such as cell phone numbers or home phone numbers are included or held back from all cards utilized by card provider, and there is no mechanism to generate contact cards with customized information based on an intended audience. As is often the case, both providers and recipients of business cards occasionally want more control beyond what traditional business cards can natively provide.

### SUMMARY OF THE INVENTION

Aspects of the present invention address shortcomings of the prior art and add new inventive features that were incapable of being implemented either by persons directly or by electronic provision of data. Typical access control features require authentication and include controlling access to information (e.g. cell phone number, shared calendar), revocation of access (e.g. deny ability to receive updates to contact information, fine-grained spam control), and policy-based handshake mechanisms (e.g. recipient must send contact info before communication allowed with sender). Aspects of the present invention provide access control information in an appropriate fashion on business cards or other contact cards, and methods of the present invention provide access control features along with processes to assist in creation of said business cards and access control management. The card recipient will access the network server and will enter a unique recipient ID to identify the business card they received. Upon receiving the unique recipient ID, the network server can check against the unique ID to ensure it is valid, has not been revoked, is not already in use, the card provider allows access, etc. If a check fails, then the network server may prohibit access. After all checks are passed, the network server can grant initial access to the card provider's contact information. In effect, each business card or contact card may act as a passkey which provides selective online access to card provider's contact information.

As utilized herein, card “provider” and “employee” may be used interchangeably, as there may be situations where a person not associated with any company wishes to utilize aspects of the present invention independently of an employer. In both roles, the outcome is similar—a person providing a contact card with a unique recipient ID to a recipient. Also, as utilized herein, “contact card” or “business card” may represent many forms of tokens to provide contact information in accordance with aspects of the present invention, and may be in the form of a physical object, such as a printed stock business card, or an electronic token in one of many forms, such as an image stored in a computer file, a video contact card, a sound file, or a standard vCard.

To achieve the benefits offered by the present invention, a system for printing business cards is envisioned which allows for generating multiple unique recipient IDs, associating the recipient IDs with a card provider/employee, and printing each of the card provider's contact cards (such as physical business cards) with a unique recipient ID associated with the card provider along with the network server location and any desired contact information (e.g. none, limited, provider ID, etc.). In addition, the system contains a network server which allows card recipients to navigate to it using the card information, enter their unique recipient ID from the card information, obtain initial access permissions to the card provider's shared information (e.g. contact info), optionally register and exchange contact information, and optionally gaining increased access to the card provider's shared information.

Card providers can also access the network server to manage card recipients after recipients have supplied their unique recipient ID. The management features cover commonly known access control mechanisms such as granting access to information not already on the card (e.g. calendar sharing, file sharing) and including those given by examples below (e.g. revocation) and adjusting permission level (e.g. cell phone # allow/deny view). Additionally, there are provided a software “wizard” or other user interface such as a web-based application, which may assist employees with creating an appropriate business card, establishing a set of permissions, and managing recipient access levels, based on their access control needs.

One embodiment of the present invention addresses a business card rendering and production (e.g. printing) system for creating contact cards such as business cards or electronic contact files so that the holder (i.e. recipient) of each contact card can be uniquely identified and granted a specific or default permission level when accessing a network server or other information resource that is associated with the card provider. The printing services and access management functions may be performed in-house in a provider's place of business, or, in alternative implementations, printing services may be provided by an external printing service that may interface to various systems of the provider's employer where access management takes place, or in yet another implementation, the card provider is presented with a web interface or mobile phone app interface that can configure print orders for printing by external service companies. The permission level may be adjusted afterwards to restrict access to a contact's sharable information. By creating and storing an access level that is associated with a unique recipient ID that is printed or stored in the contact (business) card, particular recipients may gain tailored access to information resources that the card provider is to make available, without providing unnecessary free access to wide ranging categories of information, particularly information that is sensitive in nature.

There is provided in one embodiment of the present invention a method that comprises: generating a contact card record, the record including provider identification data and recipient access information including a unique recipient ID; rendering the contact card record into a distributable contact card; authenticating input of the recipient access information to a communication destination indicated in the distributable contact card; and determining that said authenticating input step indicates the recipient access information input satisfies a predetermined resource access criterion, and upon such determination, furnishing access to resource information. In various embodiments, access instructions such as a network server location (e.g. URL, site name, or other information) may be displayed on the contact card or printed on the business card to allow recipients to easily navigate to the network server.

Aspects of the present invention are enhanced further by pre-provisioning databases that are utilized in the creation of custom orders for contact cards. Provisioning of the databases includes populating a provider database with provider information regarding one or more providers, the provider information including at least one of: a unique provider ID corresponding to the provider, the provider's name, the provider's business address, the provider's home address, the provider's work phone number, the provider's mobile phone number, the provider's work email address, the provider's personal email address, and the provider's personal web address; populating a permission profile database with one or more permission profiles respectively defining allowable actions for authorized providers to create or modify orders to produce distributable contact cards; and associating at least one permission from the permission profile database with the unique provider ID. In one aspect, the predetermined resource access criterion comprises one or more of: the unique recipient ID matches a non-revoked stored ID value; a hashed value of the recipient ID matches a hashed value of at least part of the provider identification data; records stored in a session database indicate that access has not been requested before for the unique recipient ID; a time limit for access has not expired for the unique recipient ID; resource data requested satisfies an access level criterion previously stored in relation to the unique recipient ID; and the unique recipient ID has not been marked as revoked. Those skilled in the relevant art understand that a hash value is the output of a hash function that may utilize well-known algorithms (such as SHA-1) to transform information into a format that is readable, but hides the original nature of the data that was input to the hash function.

In various embodiments, contact card designs can be created in advance and stored in a card design database; the features of the card design may include one or more of a textual and graphical layout, fields to be populated by further processing, a color scheme, and location of any access mark (described more completely below).

Access levels are defined to place bounds on the type and extent of information that may be utilized by a card recipient. In one embodiment, one or more access levels are defined and stored in an access level database for subsequent association with a particular unique recipient ID, and each respective access level establishes limits regarding content and extent of the resource information that may be accessed by the prospective recipient. Access levels allow controlled and predictable access to resource information when a recipient uses the contact information on the contact card to gain access to the controlled access management system. For example, one access level (call it “L1” for example) could be provided to allow the recipient to access only the basic contact information associated with the provider that gave them the contact card; a second access level (say, “L2” for example) may allow the recipient to access the provider's public calendar; a third access level (say, “L3” for example), may allow the recipient to access the provider's sensitive personal contact information (such as mobile phone number, home phone number, or the like); another access level (say, “L4” for example) may allow the recipient to remotely log in and access sensitive company information or new product information not readily available to the public, and so on.

Access control can be implemented for card providers who wish to create one or more contact cards in the form of permission levels. Permission levels can be previously generated and stored in a permission profiles database, and associated with a particular card provider so that aspects of the system will permit or allow, as appropriate, the provider to access certain system capabilities. For example, the permission profiles may comprise information that identifies: an allowed set of access levels that may be used by a particular provider when establishing access levels for the prospective recipient; and a permissible content and extent of information that the particular provider may designate when establishing the one or more access levels. In any event, permission profiles are an optional component of the printing process, as in certain circumstances they may not provide additional printable information for the contact card.

Aspects of the present invention provide for a method for card providers to easily (and possibly covertly) identify the level of access that will be granted a recipient of a particular contact card. During contact card generation, an access “mark” may be added to the contact card that is meaningful to the provider and that alerts the provider of the access level associated with the recipient ID on the contact card; the meaning of the mark may covertly convey to the provider that a particular contact card will allow a particular access level depending on the desired contact type. On the other hand, the mark may convey a sense of entitlement to the recipient when certain words like “VIP” or “Full Access Pass” are prominently displayed on the card. Embodiments may utilize certain visual indicia for access marks that are discernable by a human, and as mentioned above meaningful at least on a covert level. For example, the mark may be displayed on the contact card or encoded in the number to indicate default access level, e.g. unique recipient ID “1SJ67” could indicate level 1 access and unique recipient ID “2XN74” could be a level 2 access, etc. Alternatively, access marks on contact cards could have color codes or changes in visual structure such as logo size/placement that is known only to the provider regarding its correlation with access level provided to the assigned unique recipient ID for the contact card. With the combination of different indicia, it will be possible for the provider to carry a variety of cards for distribution, each individually identifiable as the level of access provided to the card recipient, which is a feature neither automated nor human-based processes have implemented. For example of use of the access mark, if a provider met a total stranger at a conference, the provider may furnish a card to the recipient that has a covert marking indicating that the recipient will only be automatically provided the lowest-level access secured information when such recipient attempts to use the contact information and the unique recipient ID on the card; however another card with a different marking protocol which may be covert or not (for instance, a punctuation mark like a star, or an emblazoned “VIP” logo) would allow the recipient of the card to access much more sensitive information. As part of provisioning database of the present invention, aspects of the invention address establishing and storing in an access mark database one or more access marks comprising indicia corresponding to the established access levels of a particular distributable contact card; and associating the one or more access marks with one or more stored access levels, and wherein the one or more access marks are formatted to covertly communicate to the provider the access level that would be provided to the prospective recipient if the prospective recipient utilizes a particular distributable contact card to access resource information. An access mark may include, for example, a human-readable graphical image; text placed in a predetermined location on the distributable contact card; text uniquely formatted on the distributable contact card; a holographic image; a unique file name; a predetermined color; and a digital signature. In yet another aspect of the present invention, the recipient ID is uniquely associated with one of a card provider or a particular recipient.

Another aspect of the present invention provides for the identification of information resources that may be accessed by card recipients. Features of the present invention identify resource information categories that may be disclosed to prospective recipients, and respectively associating the identified resource information categories with one or more of the stored access levels. For example, but not by way of limitation, a low level of information resource access may allow the recipient to obtain a cell phone number of the card provider, a medium level of information resource access may allow access to the card provider's public calendar, and higher levels of resource information access may provide information regarding new product designs and release details. Each of these categories may be pre-selected and stored for use in when generating contact cards.

One further aspect of the present invention entails creating an order request. In one embodiment, the provider initiates an order request, and configures the aspects of the order to customize the number of cards in the order, the information displayed on the cards, access marks to be displayed or omitted, and access levels desired or the intended recipients. A proxy for the provider such as an administrative assistant or a person operating the systems of the present invention may request an order that meets the provider's requirements, without requiring direct interaction of the provider with the system. In another embodiment, aspects of the present system may be implemented as an app running on the provider's mobile device, so that the provider may on demand create an order request for the generation of new contact cards. In one such aspect, the provider accesses a system application in communication with the provider database, the permission profiles database, the access mark database, and the Card ID database to generate and render the distributable contact card. In one embodiment, order generation includes selection of: the provider ID; a stored card design from the card design database; a stored access level from the access level database; zero or more stored access marks from the access mark database; and/or a number of distributable contact cards desired for production as a result of execution of the order. A plurality of unique recipient IDs equal in number to the number of distributable contact cards desired for production is then generated; and the generated unique recipient IDs are stored in a card ID database, wherein the stored unique recipient IDs are associated with the order request, the provider, and an access level of the recipient.

Unique recipient IDs may be generated by the system software using any desired technique, including an assigned block of previously-stored numbers, or calculation of new numbers through an algorithmic approach (such as to guarantee uniqueness and prevent spoofing/hacking attempts from outside access to resource information). Further, algorithmic computation supports authentication features such as use of a hash algorithm or a number formatted for checksum value. Inputs to the hash function could be a random seed or some combination of the card provider's ID number that correlates with the recipient that received a contact card from the provider. Such algorithmic generation of recipient ID codes can be generated to allow checksum validation, such as through a Luhn, or Luhn mod N algorithm, or use of Verhoeff or Damm algorithm for non-numeric recipient IDs.

In yet another aspect of the present invention, generating a contact card record further comprises: retrieving the selected provider ID from the order request; obtaining the selected stored card design from the order request; obtaining the zero or more selected access marks from the access mark database from the order request; retrieving the number of distributable contact cards desired for production from the order request; for a number of records equal to the number of requested distributable contact cards: populate fields of the contact card record in accordance with the card design by retrieving information from the provider database, the access mark database, and the Card ID database. And as a primary output of the order request process, contact card records are rendered into a form that may be distributed by the card provider. In one implementation, the contact card record is rendered into a distributable contact card by printing a business card comprising the information from the contact card record. Alternatively, in an electronic variation, a file is formatted for electronic distribution, the file format including one of: a standard vCard format; an electronic graphical image format; an electronic image file selected from the group consisting of jpg, png, gif, and tiff format; an audio file format; a video file format; an HTML file; and an XML file. Based on the selected card design, any desired information may be included with a particular contact card and an order request. For example, instructions may be provided on the card to assist with recipient access to information resources. Such instructions or assistance may take the form of a URL web address, a phone number, a network address, a QR code with at least one of the recipient ID and a URL to obtain access to the resource information embedded therein, a barcode image, and a mailing address. In yet another embodiment, the communication destination is included in one of the provider information data and the recipient access information.

Once the business cards are produced, they are physically delivered to the card provider in the case of printed cards formats, and electronically provided for non-printed contact cards. The card provider only then needs to select a card to provide to the card recipient, and transfer the distributable contact card. As mentioned above, the card provider may utilize the access mark to determine which card is appropriate to provide to a particular card recipient. Distribution can be through any desired means, and may include providing a business card embodying information from the distributable contact card to the intended recipient; electronically transferring an electronic representation of the rendered contact card to the intended recipient; emailing an electronic representation of the rendered contact card to the intended recipient; using a mobile electronic device to send an electronic representation of the distributable contact card via a text message to the recipient in one of SMS or MMS format; transferring an electronic representation of the rendered contact card to the intended recipient via a peer-to-peer electronic connection between at least two mobile devices; utilizing a first app on the card provider's mobile device to display one of a QR code and a barcode on the provider's mobile device; using a second app on the recipient's mobile device to scan the display of the provider's mobile device and process information encoded in the scanned image; and providing an electronic medium to the intended recipient that includes therein a stored electronic representation of the rendered contact card. For electronic cards, in one optional embodiment, once one electronic card is distributed by a card provider to a card recipient, the particular card may not be re-distributed again. In this way, each electronic card can be distributed to only one recipient and duplicated distribution of a same electronic card can be avoided.

Embodiments of methods of the present invention may also be implemented in a system incorporating a server architecture as described more completely below. In one embodiment there is provided a system comprising a server, where this server comprises a processor, working memory, one or more main storage devices, a user interface device, and network communication interface. The system may also include one or more data storage structures implemented as databases in communication with the server processor comprising: a provider database; a permission profiles database; an access mark database; a card design database; a card ID database; and an access level database; wherein the server is configured to execute instructions stored in the memory to: generate a contact card record, the record including: provider identification data; and recipient access information including a unique recipient ID; render the contact card record into a distributable contact card; authenticate input of the recipient access information to a communication destination indicated in the distributable contact card; and determine that said authenticating input step indicates the recipient access information input satisfies a predetermined resource access criterion, and upon such determination, furnishing access to resource information. In a system embodiment, a server of the system executes instructions further comprising: populating the provider database with provider information regarding one or more providers, the provider information including at least one of: a unique provider ID corresponding to the provider, the provider's name, the provider's business address, the provider's home address, the provider's work phone number, the provider's mobile phone number, the provider's work email address, the provider's personal email address, and the provider's personal web address; populating the permission profile database with one or more permission profiles respectively defining allowable actions for authorized providers to create or modify orders to produce distributable contact cards; and associating at least one permission from the permission profile database with the unique provider ID.

Embodiments of the network server of the present invention can require the user to register for the purposes of adding additional security. Registration may consist of creating or linking to an account profile representing the recipient and then the unique recipient ID invalidated afterwards. In some implementations, the network server provides a method for recipients to save card information entered by the recipient to the server during the registration/access process. In this manner, in future access sessions, card recipients are not required to re-enter information to be granted access to the same access level. Due to the additional security, if the original contact card is lost, stolen, or copied after account registration, then it still may be the case that the recipient has access via the account login and new users cannot use the same unique recipient ID. To address the case where the original card is lost, stolen, or copied before account registration, then, for example, there may be a time window after account creation where the unique ID is still valid, or an ability to allow the unique ID to be used multiple times up to some limit, or mechanism to request a new unique ID from the card provider via the network server. These approaches are illustrative but non-limiting of the types of solutions which may be introduced.

Certain solutions to avoid or recover from abuse of information can be provided in conjunction with network server support. One aspect of the present invention avoids providing contact information to recipients until after recipients have identified themselves via registration with the network server. In this way, the distributable contact cards do not have printed contact information by default (or only minimal contact information) and so card recipients are not granted immediate access to all contact information. Also, if desired, additional contact information can be provided via the server to card recipients after authentication has taken place.

In various embodiments, the level of initial access to the network server may be controllable by the card provider, or the organization/company the card provider (e.g. employee) works for. Initial access may be very limited and may not provide any information to the card recipient or may be limited to what is already on the distributable contact card, or some other desired combination. There is value to even this type of limited embodiment in that should a distributable contact card be lost, the recipient can still access the card provider's information via an online mechanism if desired by the card provider. Additionally, based on the level of initial access selected, each business card recipient may be viewed as having default or ‘guest’ access to the contact information. Alternatively, different business cards may be printed with different unique recipient IDs which have higher or lower ‘default’ access on a per card basis (as circumstances warrant).

### BRIEF DESCRIPTION OF THE DRAWINGS

A more complete understanding of the present invention may be derived by referring to the detailed description and claims when considered in connection with the following illustrative figures.

FIG. 1 illustrates a block diagram of a system of the present invention, showing architectural connections of databases and data flows.

FIG. 2 is a flow diagram depicting an exemplary process of the present invention with respect to provisioning databases that are used to generate contact cards by systems of the present invention.

FIG. 3 is a flow diagram depicting generation and use of contact cards of the present invention.

### DETAILED DESCRIPTION OF EXEMPLARY EMBODIMENTS

Both the foregoing summary and the following detailed description are exemplary and explanatory only and are not restrictive of the invention as claimed.

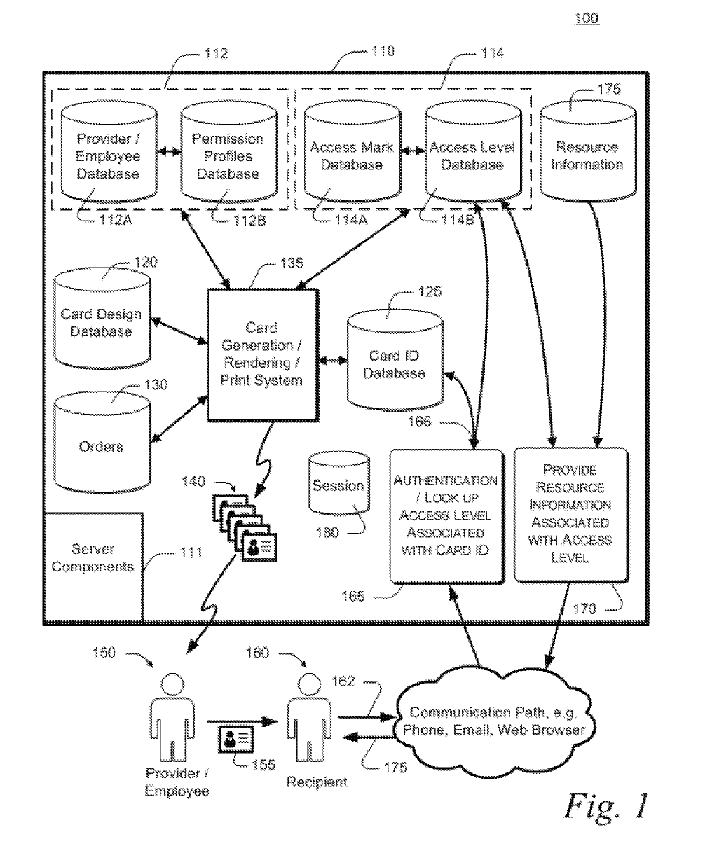

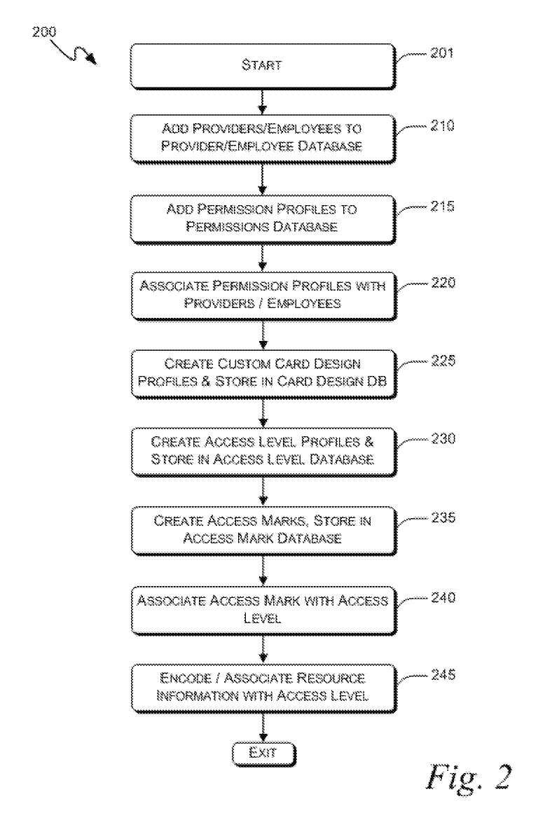

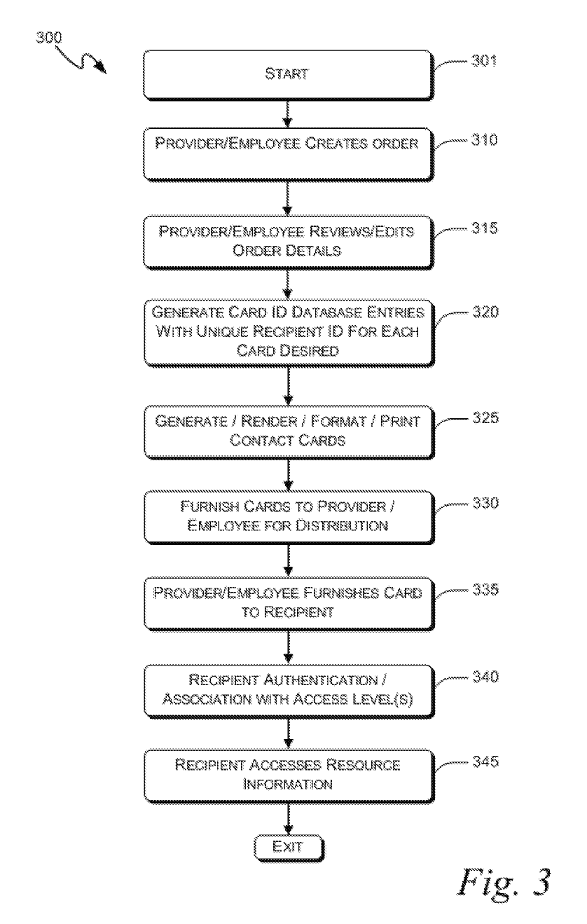

Turning to FIG. 1, a block diagram of a system 100 of the present invention is illustrated, showing architectural connections of databases and data flows. Server Components 111, while not highlighted in methods of the present invention, provide the processing power and connectivity for execution of the provided methods, and comprise at least a processor, working memory, one or more main storage devices, a user interface device, and network communication interface. A number of individual databases 112A, 112B, 114A, 114B, 175, 120, 130, and 125 are depicted as separate but interconnected data resources. Although a variety of databases are described in embodiments of the present invention, those of skill in the relevant arts can foresee various data storage configurations where one or more databases are stored within a single database, or databases that are illustrated in FIG. 1 may be implemented as tables in one or more relational databases, and also databases that may be shown in the same context with one another may be implemented in a distributed or decentralized manner. Further, remote databases containing either resource information or any of the types of data utilized herein such as provider identification data may be used to replace or augment databases illustrated herein. Databases derived from social media applications such as LinkedIn® may further supplement or replace data items herein. The system as shown in FIG. 1 will be discussed in the context of FIG. 2 and FIG. 3.

To achieve most efficient operation of the present invention, databases may be pre-provisioned with information as shown in FIG. 2. The flowchart 200 begins with adding 210 card providers (also known as employees in certain aspects of the present invention) to the provider employee database 112A. As part of this process, unique provider IDs and associated provider identification data is stored for one or more card providers/employees, in the provided database 112A, and this process is repeated for as many card provider/employees as desired that may be requesting card orders. Typical information stored may include, for example, a unique provider ID corresponding to the provider, the provider's name, the provider's business address, the provider's home address, the provider's work phone number, the provider's mobile phone number, the provider's work email address, the provider's personal email address, and the provider's personal web address. Next, one or more permission profiles are created 215 and stored in the permission profile's database 112B. These permissions define, for example, how a particular provider can access the system such as creating card designs, using or hiding cell phone numbers, creating a certain number of cards, or allowable access levels that provider may specify in creating cards for recipients. As many permissions may be created as required to allow administrative control of the system while still providing sufficient flexibility for card providers/employees to create cards that suit their needs. Once permissions are created, one or more card providers/employees (in one case, through the provider ID) may be associated 220 with one or more of the permissions in the permission profiles database 112B. The dotted box 112 illustrates the associated databases for the provider employee database 112A and the permission profiles database 112B.

To increase the ease at which contact cards may be generated, custom card designs may be created 225 in advance and stored in a card design database 120. As many custom card designs may be created as desired for particular recipient audience, and may include features such as a textual and graphical layout, fields to be populated by further processing, a color scheme, and location of any access mark (described more fully below). Further, one or more access level profiles are created 230 and stored in the access level database 114B. As described above, access levels defined what information resources a particular card recipient may be allowed to view or download. For example, one level of access may grant the card recipient the contact information of an employee, a higher access level may also grant the recipient access to the employee's public calendar, and an even higher level of access may grant the card recipient the right to access sensitive business information. Card providers/employees may be restricted by the permissions associated with them in the permission profiles database 112B, so that reasonable limits may be placed upon what information becomes distributed by certain employees.

As described above, access marks provide a means for card provider to easily determine what access level a particular card may convey to a recipient. One or more access marks may be created 235 and stored in an access mark database for use in selection and generation of particular cards. Multiple levels of access may be indicated by the type of access mark used on a particular card. Once access marks are created and stored in the access mark database 114A, they are respectively associated 240 with defined access levels that have been stored in the access level database 114B. Finally in FIG. 2, resource information that is intended to be provided to a card recipient is associated 245 with particular access levels stored in the access level database 114B. For example, one such association could comprise setting the disclosure of a cell phone number as “Require L-2 access for recipient to view.”

Turning to FIG. 3, a flowchart 300 shows a process for generation and use of contact cards of the present invention. The process begins with a provider creating an order 310. The provider accesses the system, and the provider's ID is retrieved from the provider database 112A, and the provider specifies a selection of card design, access level, access marks (if any), and the number of distributable contact cards desired for production. The card generation rendering and print system 135 then populates the fields of the contact card records in accordance with the card design by retrieving information from the provider database 112A, access marks database 114A, and recipient IDs from the card ID database 120. The choices selected by the provider are then displayed for review in an order request, and the provider is given an opportunity to modify the order 315 or otherwise make changes. Once the order is sufficiently reviewed and ready, a plurality of unique recipient IDs equal in number to the number of distributable contact cards desired for production are generated and stored 320 in the card ID database 125 for processing in the order request.

At step 325, the system is ready to generate, render, format, and/or print contact cards according to the order request. If physical contact cards are desired, card generation and print system 135 accesses from the order request the employee ID, the card design, the desired access mark, and the number of cards, and respectively prints each card with the relevant information, including a unique recipient ID for each card, and optional access mark corresponding to the recipient ID's accessible level of access. This process continues for each card requested in the order, namely, for each field in the card design selected in the order, obtain the content from the applicable database, populate the field with the obtained content, and print the card design with the fields onto the card. Once printed, contact cards are furnished 330 to the provider for distribution 335. Should electronic contact cards be desired, the card generation print system 135 formats records in a similar manner as previously described, however creating them in a format selected by the provider, and making the electronic contact cards accessible (such as by storing in a database accessible by the provider) for the provider to use and distribute through electronic means or through a storage medium (such as a flash drive, a magnetic medium, or optical medium) provided to the recipient. As shown at the bottom of FIG. 1, once the provider 150 has been furnished with contact cards 140, the provider may select a card 155 and deliver to the recipient 160.

Once the recipient 160 has received a contact card 155, the recipient 160 can follow instructions on the card to access 162 a service identified by the card through conventional communication paths such as phone email web browsers. Once a recipient 160 attempts to access the system 110 to gain access to the resource information 175, the recipient 160 is authenticated and associated with an access level 165, 340 based upon the associated unique recipient ID provided by the recipient 160 as prompted by the system 110, 165. Once authenticated, the recipient may be granted access to resource information 175 as governed by the access rules established in the access level database 114B, and card ID database 125 for that recipient, and information may be provided 345 accordingly 170. For a simple example, a recipient may follow a URL printed on the contact card 155, and when prompted by the system component 165, enters the unique recipient ID printed on the card 155, then is directed to a particular website through the resource information database 175 that provides additional contact information for the card provider 150. The recipient's access to the system 110 is tracked through session process 180, maintaining a record of the recipient's access to the system, the resources accessed, the date and time of the access, and any other relevant information desired for tracking. As the authentication function 165 may find that the recipient's ID is no longer valid, the recipient may be denied access if necessary. On the other hand, if a card provider 150 is granted sufficient permission in the permission profiles database 112B, the provider may escalate the level of access that is available to the recipient 160, by modifying the association between the recipient ID stored in the card ID database 125, and the access level database 114B. Further, certain conditions may lead to the expiration of a particular recipient ID, such as a minimum amount of time lapsing since the card 155 was conveyed to the recipient 160, indications of hacking or unauthorized access, indication that the card 155 had been lost or misplaced, or other conditions warranting exclusion of the recipient from access to the resource information 175.

Any combination and/or subset of the elements of the methods depicted herein may be practiced in any suitable order and in conjunction with any suitable system, device, and/or process. The methods described and depicted herein can be implemented in any suitable manner, such as through software operating on servers, distributed processors, or mobile devices (such as in the form of an installed app), or service running on a host server connected to a network such as the Internet. The software may comprise computer-readable instructions stored in a medium (such as the memory of the mobile device or server) and can be executed by one or more processors to perform the methods of the present invention.

The particular implementations shown and described above are illustrative of the invention and its best mode and are not intended to otherwise limit the scope of the present invention in any way. Indeed, for the sake of brevity, conventional data storage, data transmission, and other functional aspects of the systems may not be described in detail. Methods illustrated in the various figures may include more, fewer, or other steps. Additionally, steps may be performed in any suitable order without departing from the scope of the invention. Furthermore, the connecting lines shown in the various figures are intended to represent exemplary functional relationships and/or physical couplings between the various elements. Many alternative or additional functional relationships or physical connections may be present in a practical system.

Changes and modifications may be made to the disclosed embodiments without departing from the scope of the present invention. These and other changes or modifications are intended to be included within the scope of the present invention, as expressed in the following claims.

1. A method comprising:
generating a plurality of unique recipient IDs equal in number to a number of printed contact cards desired for an order request associated with a provider person;
generating a plurality of contact card records, each contact card record including a unique recipient ID;
rendering the contact card records to make printed contact cards, each printed contact card rendered with one of the contact card records which includes one of the unique recipient IDs;
for one of the printed contact cards obtained by a recipient person from the provider person, receiving by a computer from the recipient person the unique recipient ID on the printed contact card, and determining by the computer that the received unique recipient ID satisfies a predetermined resource access criterion, and upon such determination, providing the recipient person with contact information of the provider person; followed by
receiving by the computer registration information from the recipient person, the registration information identifying the recipient person; and
after receiving the registration information, providing the recipient person with more information about the provider person.

2. The method of claim 1 further comprising:
populating a provider database with provider information regarding one or more provider persons, the provider information including a unique provider ID corresponding to the provider person, and at least one of: the provider person's name, the provider person's business address, the provider person's home address, the provider person's work phone number, the provider person's mobile phone number, the provider person's work email address, the provider person's personal email address, and the provider person's personal web address;
populating a permission profile database with one or more permission profiles respectively defining allowable actions for authorized provider persons to create or modify orders to produce printed contact cards; and
associating at least one permission from the permission profile database with the unique provider ID.

3. The method of claim 1 further comprising creating a contact card design and storing the design in a card design database, wherein features of the card design include one or more of:
a textual and graphical layout;
fields to be populated by further processing;
a color scheme; and
location of any access mark.

4. The method of claim 2 further comprising:
establishing and storing in an access level database one or more access levels for a prospective recipient person, whereby each respective access level establishes limits regarding content and extent of information about the provider person that may be accessed by the prospective recipient person.

5. The method of claim 4 further comprising:
wherein the permission profiles comprise information that identifies:
an allowed set of access levels that may be used by a particular provider person when establishing access levels for the prospective recipient person; and
a permissible content and extent of information that the particular provider person may designate when establishing the one or more access levels.

6. The method of claim 4 further comprising:
establishing and storing in an access mark database one or more access marks comprising indicia corresponding to the established access levels of a particular printed contact card; and
associating the one or more access marks with one or more stored access levels, wherein the one or more access marks are formatted to covertly communicate to the provider person the access level that would be provided to the prospective recipient person if the prospective recipient person utilizes a particular printed contact card to access information about the provider person.

7. The method of claim 6, wherein the indicia comprises one or more of:
a human-readable graphical image;
text placed in a predetermined location of the printed contact card;
text uniquely formatted on the printed contact card;
a holographic image;
a unique file name;
a predetermined color; and
a digital signature.

8. The method of claim 4 further comprising:
identifying, by the computer, categories of information about the provider person that may be disclosed to the prospective recipient person; and
respectively associating the identified categories with one or more of the stored access levels.

9. The method of claim 1 wherein the predetermined resource access criterion comprises one or more of:
the unique recipient ID matches a non-revoked stored ID value;
records stored in a session database indicate that access has not been requested before for the unique recipient ID;
a time limit for access has not expired for the unique recipient ID; and
the unique recipient ID has not been marked as revoked.

10. The method of claim 6 further comprising, before generating the plurality of unique recipient IDs:
creating the order request including selection of:
the provider ID,
a stored card design from a card design database,
zero or more stored access marks from the access mark database, and
the number of printed contact cards desired for production as a result of execution of the order request; and
storing the generated unique recipient IDs in a card ID database, wherein each of the stored unique recipient IDs is associated with the order request, the provider person, and one of the stored access levels.

11. The method of claim 10, wherein generating the plurality of contact card records further comprises:
retrieving the selected provider ID from the order request;
obtaining the selected stored card design from the order request;
obtaining the zero or more selected access marks from the access mark database from the order request;
retrieving the number of printed contact cards desired for production from the order request;
for a number of records equal to the number of requested printed contact cards:
populate fields of the contact card record in accordance with the card design by retrieving information from the provider database, the access mark database, and the Card ID database.

12. (canceled)

13. The method of claim 11, wherein the provider person accesses a system application in communication with the provider database, the access mark database, and the Card ID database to generate and render the contact cards to make the printed contact cards.

14. The method of claim 1 wherein each of the contact card records, which are rendered to make the printed contact cards, further includes one of a URL web address, a phone number, a network address, a QR code with at least one of the recipient ID and a URL to obtain access to the resource information embedded therein, a barcode image, and a mailing address.

15. The method of claim 1, wherein the unique recipient ID is uniquely associated with the provider person and the recipient person.

16-33. (canceled)
